(19) United States
(12) Patent Application Publication
(10) Pub. No.: US 2025/0387841 A1
(43) Pub. Date: Dec. 25, 2025

(54) ASSEMBLY OF A REAMING TOOL, CONSISTING OF CLAMPING PART, REAMING BIT AND A DISMANTLING KEY AND METHOD OF DISMANTLING OF THE REAMING TOOL

(71) Applicant: FINAL Tools a.s., Brno (CZ)

(72) Inventor: Stanislav FIALA, Brno (CZ)

(21) Appl. No.: 19/244,545

(22) Filed: Jun. 20, 2025

(30) Foreign Application Priority Data
Jun. 21, 2024 (CZ) PV 2024-251

(51) Int. Cl. B23D 77/02

(52) U.S. Cl. CPC B23D 77/025; B23D 2277/02; B23D 2277/2464; B23D 2277/58

(57) ABSTRACT

Assembly of a reaming tool, that includes a clamping part, a reaming bit and a dismantling key. The clamping part is provided with a driving pin and with a hollow seating central protrusion. The reaming bit is provided with a central through opening for depositing on the seating central protrusion of the clamping part. On a cutting part a frontal surface is provided with a central axis on which a through conical opening is provided. On the clamping part of the reaming tool a frontal abutting surface is provided. In the central axis of the clamping part, there is a tubular conical protrusion, whose apex angle is smaller than the apex angle of the through conical opening. On the frontal abutting surface of the clamping part at least one recess is provided corresponding in shape to the functional part of the dismantling key.

### TECHNICAL FIELD

The invention concerns a new design of the connection between two parts of the reaming tool, namely the connection of a cutting part with a clamping part of the tool with a high precision coaxial connection of both parts of the tool.

### STATE OF THE ART

From documents solutions of tool systems are known, which consist of a clamping part provided with a driving protrusion and a hollow central seating protrusion made in the axis, around which there is a circular recess, and on the protrusion, the cutting part, which is a bit with cutting edges, is placed, and which, after seating on the circular recess, is fixed to the clamping part by a screw provided at one end with a cylindrical head with an internal hexagonal opening and at the opposite end with an external thread which interacts with the internal thread in the clamping part.

Such an embodiment is known, for example, from GB1233953, U.S. Pat. No. 6,053,670, US 2017/0266734 A1 or EP 4237183 A1. The connection made in this way of the clamping and cutting part does not ensure the necessary precision of the mutual connection of the two parts.

For example, the connection between the holder and the cutting head is known from EP1240963B1. Between the tool holder and the cutting head of the tool, a threaded coupling is provided. The threaded coupling has two opposing threaded parts which are provided as external threads with opposite orientation and which interact with the internal threads of the tool holder and the cutting head. The tool head has a conical protrusion and there is a conical opening in the face of the holder into which, when the threaded coupling is screwed in, the inner faces of the tool parts fit tightly together, whereas the conical protrusion in the face of the cutting head fits without clearence into the conical opening in the face of the holder, thus achieving a very precise axial connection between the two parts of the reaming tool.

The main disadvantage of these well-known technical solutions is that the cutting part is in most cases made of structural steel, to which carbide tips are attached by soldering at a temperature of 600-800° C. and then the tips are very precisely geometrically machined. In many cases, the very precisely machined tips are coated with wear-resistant coatings at a temperature of 300-500° C. The different thermal expansion of the steel and the sintered carbide during the coating process causes deformation of the cutting tips, which in the case of multi- tip axial tools causes the situation that cutting tips after the application of the wear- resistant coating are not exactly on the same orbit and thus it leads to incorrect tool function.

In order to eliminate the above mentioned problem, a tool cutting part is produced in a less frequent case from a monolith of sintered carbide, e.g. according to the well-known design from EP1240963B1. However, this production is very expensive and in many cases economically unacceptable.

From CZ 308960 B1 a variant is known where only a bit formed as a three-edged reamer with two guiding surfaces in the shape according to EP 1657014B1 is fixed on the clamping holder. For precise clamping, an opening is provided in the face of the holder, and on the circumference of the reaming bit, opposite to the central tooth protrusion, a driving groove is formed into which the driving protrusion extends, which is formed on the face of the holder whereas in the axis of the reaming bit a cylindrical opening is provided to accommodate the alignment coupling screw provided on one of its end with an external thread and on the other side with a head with abutting face, below which is a continuous cylindrical shank terminating in another abutting face, and the upper shank is followed by a lower shank with a smaller diameter. This tool allows only the bit to be replaced and the holder remains. However, the production of the alignment shanks is very difficult.

The aim of the invention is to simplify the construction of combined reaming tools with cutting part and clamping part so that the cutting part of the reaming tool is made of a monolith of sintered carbide with lower production costs compared to the well-known tools mentioned above. Furthermore, the aim is to achieve a very precise coaxial connection between the clamping and cutting part of the tool.

### SUMMARY OF THE INVENTION

The above-mentioned deficiencies are eliminated by an assembly of reaming tool, its clamping part and a dismantling key according to the characterizing part of the claim one.

### BRIEF DESCRIPTION OF DRAWINGS

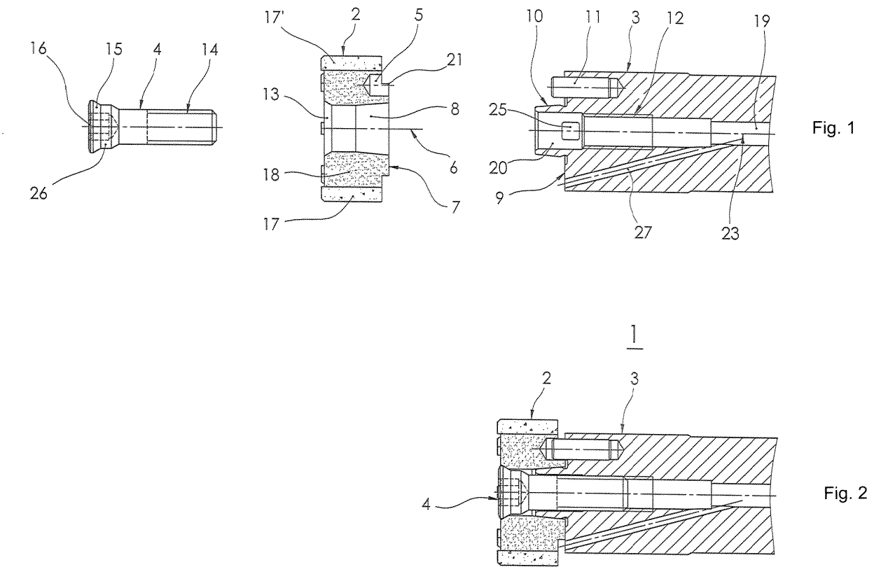

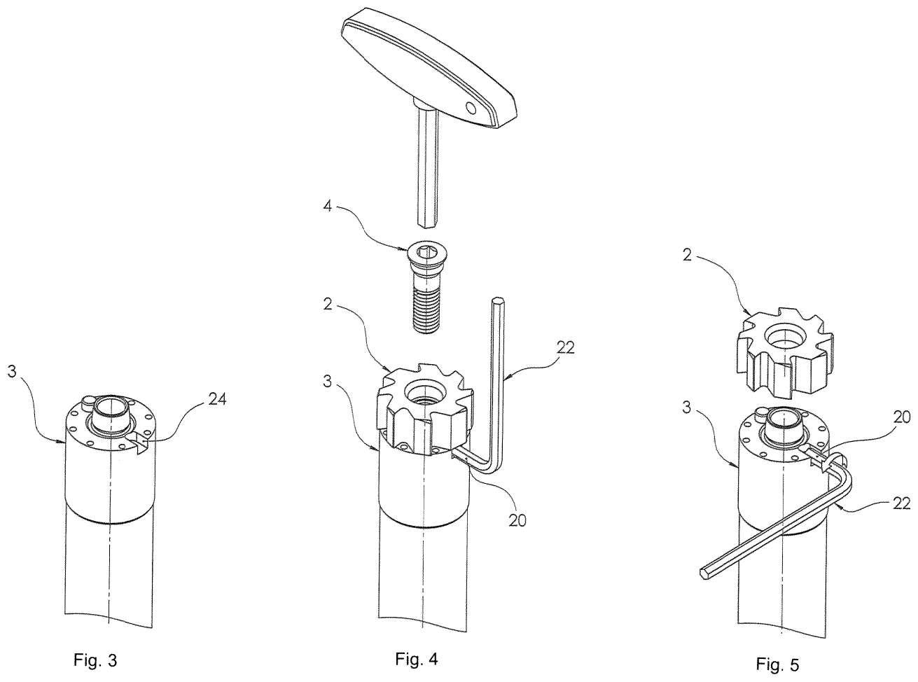

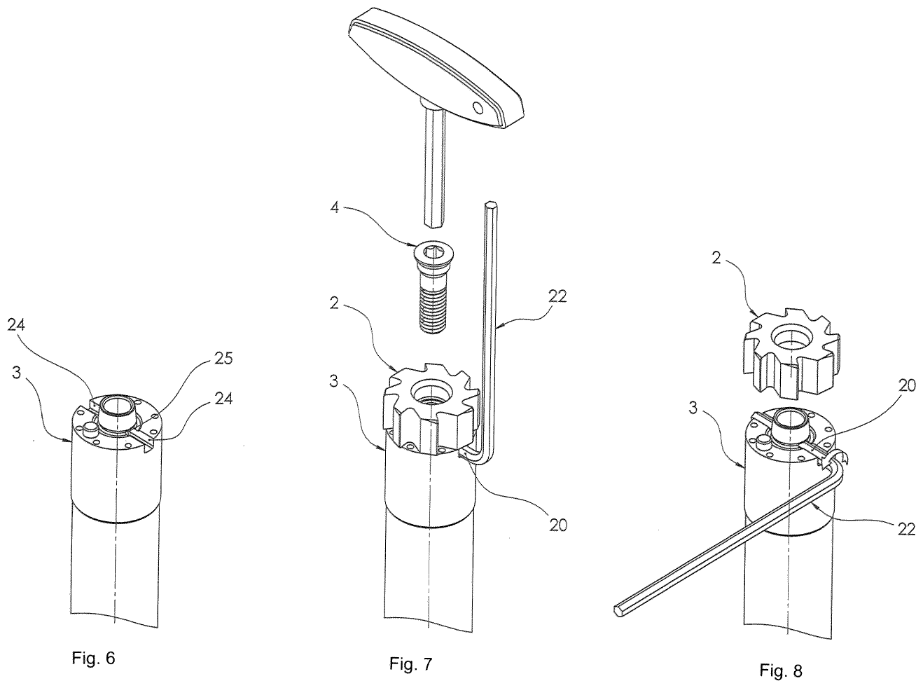

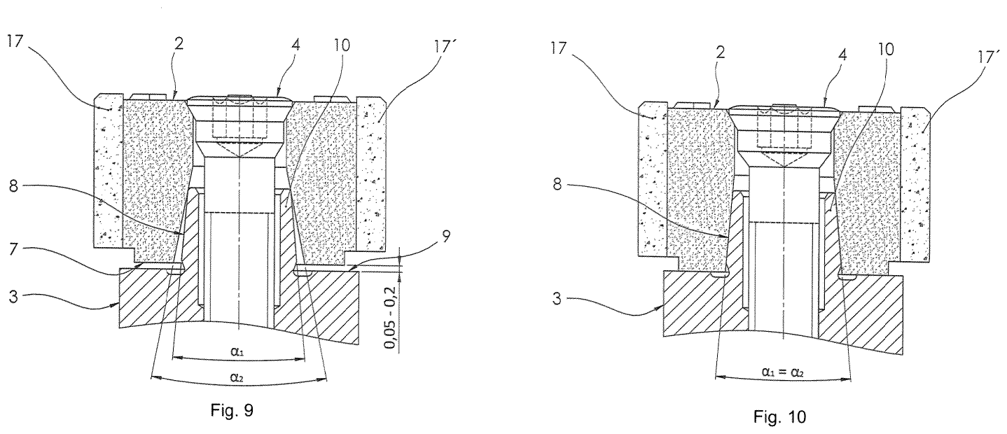

The invention will be explained in more detail by means of drawings, where FIG. 1 shows the exploded assembly of the reaming tool and its clamping part, FIG. 2 is a view of the clamped assembly of the reaming tool and its clamping part, FIG. 3 is a view of the clamping part of the assembly in the first embodiment, FIGS. 4,5 show an assembly of a reaming tool, its clamping part and a dismantling key according to the invention in the first embodiment, FIG. 6 is a view of the clamping part of the assembly in a second embodiment, FIGS. 7, 8 show an assembly of a reaming tool, its clamping part and a dismantling Allen key according to the invention in a second embodiment and FIGS. 9 and 10 illustrate in detail how the reaming tool and clamping part are assembled together according to the invention.

### DESCRIPTION OF PREFERRED EMBODIMENTS OF THE INVENTION

FIGS. 1 and 2 show a part of the reaming tool assembly 1 with a cutting part 2 and its clamping part 3, still without the dismantling key. The assembly comprises the cutting part 2 and this is mounted on the clamping part 3 and the both parts are connected by a clamping screw 4 provided at one end with a cylindrical head 26 having an inner hexagonal opening 16 and a conical outer seat 15 which abuts a conical inner seat 13 of the cutting part 2, and at the other end of the screw 4 there is an external thread 14 which engages with an internal thread 12 of the clamping part 3.

On a frontal abutting surface 9 of the clamping part 3, a driving pin 11 is provided, which interacts with the driving opening 5 on the frontal annular surface 7 of the cutting part 2 and which serves to safely transfer the torque transmitted from the clamping part 3 to the cutting part 2. There is also a circumferencial recess 21.

On the cutting part 2, there is a frontal annular surface 7 and in its central axis 6 there is a through conical opening 8, and on the clamping part 3 there is the frontal abutting surface 9 and in its central axis 23 there is a tubular conical protrusion 10 whose apex angle of the cone is smaller than the apex angle of the through conical opening 8, whereas in the clamped state of the cutting part 2 and the clamping part 3 of the tool, their conical and frontal surfaces are securely adjacent to each other.

In the clamping part 3, a central channel 19 and side channels 27 are formed into which a cooling medium can be fed, which also serves as a lubricant. FIGS. 1 and 2 show the cutting part 2, the body 18 of which is made of sintered carbide or hard steel, on which cutting tips 17 of superhard cutting materials such as, for example, polycrystalline diamond, polycrystalline cubic boron nitride, cermet with silver solder are soldered. FIGS. 3 to 8 show the cutting part 2 which is made from a monoblock of sintered carbide. The design of the cutting edges of the cutting tips 17 is essentially irrelevant, so will not be explained here.

The central channel 19 and the side channels 27 for conducting the cooling medium are arranged in such a way that the cooling medium in the assembled state discharges preferably in the section of the cutting tips 17, and thus cools and lubricates the machining section.

Assembly of the tool with the cutting part 2 and the clamping part 3 is carried out by tightening the clamping screw 4 so that the conical inner surface of the through conical opening 8 of the cutting part 2 first sits on the tubular conical protrusion 10 (FIG. 9), the apex angle α₁ of which is smaller than the apex angle α₍₂₎ of the through conical opening 8, whereas between the frontal surfaces 7, 9 a reasonable clearance of preferably 0.05-0.2 mm is created. Further tightening of the clamping screw 4 (FIG. 10) causes elastic deformation of the wall of the tubular protrusion 10 and thus allows the frontal surfaces 7, 9 of the parts 2, 3 to be seated, whereby the conical surfaces of the conical protrusion 10 and the through conical opening 8 fit securely together and thus become firmly adhered. As a result, even when the clamping screw 4 of the already clamped parts 2, 3 is screwed out, the connection between clamped parts 2, 3 is not freely detachable. Therefore, it is necessary to dismantle the assembled cutting bit and its clamping part (FIGS. 5 and 8) in a special way. This is carried out by means of the dismantling key 22, in the illustrated example Allen key, which is also part of assembly 1, by angularly turning its functional part 20, which interacts with the frontal annular surface 7 (FIG. 1), thereby separating the cutting part 2 and the clamping part 3.

Method of disassembling the cutting and clamping part of the tool in the first embodiment of FIGS. 3, 4, 5 is carried out in a following way:

After removing the clamping screw 4 (FIG. 4), the functional part 20 of the disassembling key 22 is inserted into the recess 24 and by turning it at an angle (FIG. 5), the parts 2,3 of the assembly 1 are disassembled.

Method of disassembling the cutting and clamping part of the tool in the second embodiment of FIG. 6, 7, 8 is carried out in the following way:

After removing the clamping screw 4 (FIG. 7), the functional part 20 of the disassembly key 22 is inserted into one of the two radially formed recesses 24 arranged oppositely to each other in one axis, and subsequently functional part 20 of the dismantling key 22 is inserted through the opening 25 up to the second recess 24, and by angularly rotating the functional part 20 of the dismantling key 22 (FIG. 8), the parts 2, 3 of the assembly 1 are disassembled.

### LIST OF REFERENCE SIGNS

1—Assembly
2—Cutting part
3—Clamping part
4—Clamping screw
5—Driving opening
6—Central axis of the cutting part
7—Frontal annular surface
8—Through conical opening
9—Frontal abutting surface
10—Tubular conical protrusion
11—Driving pin
12—Internal thread
13—Conical inner seat
14—External thread
15—Conical outer seat
16—Inner hexagonal opening
17—Cutting tips
18—Body of cutting part
19—Central channel
20—Functional part
21—Circumferrential recess
22—Dismantling key
23—Central axis of the clamping part
24—Recess
25—Connection through opening
26—Cylindrical head
27—Side channel

1. Assembly of a reaming tool, comprising a clamping part, a reaming bit and a dismantling key, the clamping part is provided with a driving pin and with a hollow seating central protrusion and the reaming bit is provided with a central through opening for depositing on the seating central protrusion of the clamping part, wherein on a face of a cutting part there is a driving opening and both parts are connected by a clamping screw provided at one end with a cylindrical head having an internal hexagonal opening and at an opposite end with an external thread which interacts with the internal thread of the tool clamping part, wherein on the cutting part a frontal annular surface is provided, in its central axis a through conical opening is provided and on the clamping part of the reaming tool a frontal abutting surface is provided and in a central axis of the clamping part, there is a tubular conical protrusion, whose apex angle of the cone is smaller than the apex angle of the through conical opening, and on the frontal abutting surface of the clamping part at least one recess is provided corresponding in shape to a functional part of the dismantling key.

2. Assembly according to claim 1, wherein on the frontal abutting surface of the clamping part there are two radially formed recesses arranged oppositely to each other in the same axis and in the tubular conical protrusion a connection through opening is provided for complete insertion of the functional part of the dismantling key.

3. Assembly according to claim 1, wherein cutting part is made of a sintered carbide monoblock.

4. Assembly according to claim 1, wherein the body of the cutting part is made of a monobloc of sintered carbide or hard steel, on which cutting tips are arranged made of superhard cutting materials.

5. Assembly according to claim 1, wherein the functional part of the disassembly key is made of hardened steel and has a non-circular, square or oval profile in cross section.

6. Assembly according to claim 1, wherein the disassembly key is made as an Allen key.

7. Method of dismantling of a reaming tool according to claim 1, wherein after removing the clamping screw, the parts are disassembled by inserting a functional part of the dismantling key into at least one semi-open recess and the parts are disassembled by angularly rotating it.

8. Method dismantling of a reaming tool according to claim 7, wherein the parts are disassembled by, by inserting the functional part of the disassembly key into one of the semi-open recess and then inserting it through the opening up to the other semi-open recess and by angularly rotating the functional part of the dismantling key, the parts of the assembly of a reaming tool are disassembled.
